(19) United States
(12) Patent Application Publication
(10) Pub. No.: US 2017/0356578 A1
(43) Pub. Date: Dec. 14, 2017

(54) HOSE CONNECTOR AND METHOD FOR THE FLUID-TIGHT CONNECTION OF ONE END OF A FLUID LINE TO SUCH A HOSE CONNECTOR

(71) Applicant: NORMA GERMANY GMBH, Maintal (DE)

(72) Inventors: Detlef HENRICH, Limeshain (DE); Mathias KRAUSS, Nidderau (DE); Manfred KRUEGER, Buedingen (DE); Stephan MANN, Biebergemuend (DE)

(73) Assignee: NORMA GERMANY GMBH, Maintal (DE)

(21) Appl. No.: 15/538,995

(22) PCT Filed: Dec. 15, 2015
(86) PCT No.: PCT/EP2015/079902

§ 371 Date: Jun. 22, 2017

(30) Foreign Application Priority Data
Jan. 9, 2015 (DE) 10 2015 100 236.1

(51) Int. Cl. F16L 33/20; F16L 33/18

(52) U.S. Cl. CPC F16L 33/20; F16L 33/18

(57) ABSTRACT

The invention relates to a hose connector with an inner sleeve (2) and an outer sleeve (3) between which an annular space (5) is formed at least in a first end region (4), in which annular space one end (7) of a fluid line (8) is received. Furthermore, the invention relates to a method for the fluid-tight connection of one end of a fluid line to a hose connector. The hose connector is intended to be permanently and securely connected to the fluid line with little effort. Therefore, by means of crimping the inner sleeve (2) and the outer sleeve (3) in the end region (4), a force-fitting and form-fitting connection between the end (7) of the fluid line (8) and the hose connector (1) is formed.

The invention relates to a hose connector according to the preamble of claim 1 and to a method for the fluid-tight connection of one end of a fluid line to such a hose connector.

Hose connectors serve generally as connection pieces which are fixedly connected to an open end of a fluid line, such as a hose or a pipe. Subsequently, a connection to a further element, such as a further fluid line, a container or similar, can be established via the hose connectors. It is also possible to provide the hose connector with a cap and to in this way close off the fluid line in a fluid-tight manner.

For the secure reception of the end of the fluid line, the end of the fluid line is fed into an annular space which is formed between an outer sleeve and an inner sleeve of the hose connector. The end usually bears on the inside against the inner sleeve and on the outside against the outer sleeve. In order now to prevent a removal of the fluid line from the hose connector, it is known to provide the inner sleeve and/or the outer sleeve with projections. However, these can lead to damaging of the fluid line and make it more difficult to feed the end of the fluid line into the annular space.

Such a hose coupling with inner sleeve and outer sleeve for detachable connection to a hose is known from DE 197 43 825 A1, wherein beads, which are intended to prevent loosening of the hose, are made in the inner sleeve and/or outer sleeve. As a result of these beads, it is also very difficult, however, to feed the hose into the annular space between inner sleeve and outer sleeve.

DE 195 27 496 A1 discloses a plastics pipe provided with a connection piece, wherein the plastics pipe has a stepped end region. In a region of greater diameter, a crimp fold of the inner sleeve is made in order to secure the plastics pipe to the connection piece. In a region of lesser diameter, the plastics pipe is provided with a ring seal, which seals off from the outer sleeve.

However, the known solutions are relatively complex in terms of handling, or not sufficiently secure.

The object of the invention is therefore to remedy the drawbacks of the prior art and, in particular, to define a hose connector and a method with which a secure connection without additional connecting means is possible with little effort.

This object is achieved by a hose connector having the features of claim 1 and by a method having the features of claim 12. Embodiments are the subject of the subclaims.

In a hose connector having an inner sleeve and an outer sleeve, between which, at least in a first end region, is formed an annular space in which one end of a fluid line is accommodated, it is provided according to the invention that, by means of crimping of the inner sleeve and of the outer sleeve in the end region, a non-positive and positive connection is formed between the end of the fluid line and the hose connector.

Following insertion of the end of the fluid line into the annular space, both the outer sleeve and the inner sleeve have thus been crimped, i.e. plastically, and thus permanently, deformed, in order to produce a permanent connection to the fluid line, which connection is difficult to release. As a result of the double-sided crimping, not only a particular strength of the connection, but also a material reinforcement in the region of the interface, is here obtained. Seal tightness, holding force and pressure resistance are in this way increased. In addition, a material strength of the hose connector can be reduced while the rigidity remains constant, and so a more compact construction can be achieved.

In a particularly preferred embodiment, by means of crimping, into the outer sleeve at least one radially inwardly projecting crimp fold and into the inner sleeve at least one radially outwardly projecting crimp fold are formed, wherein the outer sleeve, in the region of the crimp fold, is pressed into an outer side, and the inner sleeve, in the region of the respective crimp fold, is pressed into an inner side of the end of the fluid line. The inner sleeve is thus more strongly deformed than the outer sleeve. As a result, a surface of the outer sleeve can remain relatively flat. Through the interaction of the crimp fold of the outer sleeve with the crimp fold of the inner sleeve, a high holding force is achieved.

Preferably, the inner sleeve is more strongly plastically deformed in the region of its crimp fold than the outer sleeve in the region of its crimp fold. The inner sleeve is in the radial direction thus more strongly deformed than the outer sleeve, the outer side of which can thereby remain relatively smooth.

A thickness of the fold, i.e. the extent to which the crimp fold is pressed into the fluid line or the amplitude of the plastic deformation, is dependent, inter alia, on the diameter and material of the fluid line. It is here particularly preferred that a compression of the wall of the fluid line between 15 and 50%, in particular between 20 and 40%, is achieved. A sufficient seal tightness and holding force is thus achievable, wherein, if a plurality of crimp folds are formed, these can be formed, where appropriate, with lesser thickness.

A preferred crimp radius, i.e. a radius of the crimp fold, can lie in particular within the range between 0.8 mm and 2 mm, in particular between 0.8 mm and 1.2 mm. Sharp edges, which could lead to damaging of the fluid line, are in this way avoided.

If a plurality of crimp folds are formed in the outer sleeve and/or inner sleeve, the respective crimp folds can preferably merge steadily into one another, so that a uniform deformation and a relatively long holding region is obtained.

Particularly preferably, the crimp fold of the inner sleeve is configured in the form of an annular groove, which, in particular, has a triangular cross section. Thus, a holding force, which is evenly distributed in the peripheral direction, and a high seal tightness, are achieved.

In a preferred embodiment, the outer sleeve has at least two crimp folds, which are pressed, in particularly differently strongly, into the end of the fluid line. A holding force of the connection can thus be set relatively accurately.

In an advantageous embodiment, the crimp fold of the outer sleeve is configured as an external thread. As a result of the external thread shaped out on an outer side of the outer sleeve, an additional functionality is obtained. In this way, the hose connector can be easily bolted to further elements. The crimp fold created by the formation of the external thread on the inner side of the outer sleeve then serves for the non-positive and positive connection to the fluid line.

Preferredly, the crimp fold of the outer sleeve is configured as annular groove portions lying on at least one peripheral line. The crimp fold is thus not configured as a continuous annular groove, which would constitute an alternative embodiment, but only as annular groove portions between which non-deformed portions remain. These non-deformed portions can then serve, for example, as a contact surface for further elements.

In a preferred refinement, the annular groove portions lie on two mutually parallel peripheral lines and are arranged with a gap in-between. This produces a high holding force.

Preferably, at least one of the crimp folds of the outer sleeve ends axially closer to the end of the first end region than the crimp fold of the inner sleeve. The crimp fold of the inner sleeve is thus located closer to the middle of the hose connection. The crimp folds of inner sleeve and outer sleeve can also at least partially overlap.

Preferably, the inner sleeve and the outer sleeve bear in a second end region one against the other, wherein, in particular, an outside diameter of the hose connector is smaller in the second end region than in the first end region. In the second end region, a material doubling thus exists, so that said end region is relatively stable. By introduction of the second end region into corresponding elements, the hose connector can thus be connected to these relatively easily and can in this way enable a fluid-tight attachment of the fluid line.

It is here particularly preferred that the inner sleeve and the outer sleeve, in the second end region, are materially connected to each other. A leakage is thus precluded. At the same time, a secure connection of outer sleeve and inner sleeve, which for this reason, for instance, are configured in one piece with one another, yet can also be bonded or welded to one another, is ensured.

In a preferred embodiment, an annular groove, in which a sealing ring is arranged, is formed into the inner sleeve. Via this sealing ring, a seal can then be made with respect to an element which has been fed from the open end of the second end region into the hose connector.

The second end region can be bent over at least partially radially outward. This produces a holding collar, on which, for instance, a clamp can act in order to secure the hose connector on a further element.

The object is achieved by a method for the fluid-tight connection of one end of fluid line to a hose connector according to one of claims 1 to 11, in that the inner sleeve and the outer sleeve are pressed by means of crimping into the end of the fluid line, with the formation of a non-positive and positive connection. A double-sided crimping, and thus a bilateral non-positive and positive connection, is thus realized between the end of the fluid line and the hose connector.

Further features, details and advantages of the invention emerge from the wording of the claims and from the following description of illustrative embodiments on the basis of the drawings, in which:

FIG. 1 shows a sectioned side view of a hose connector of a first embodiment,

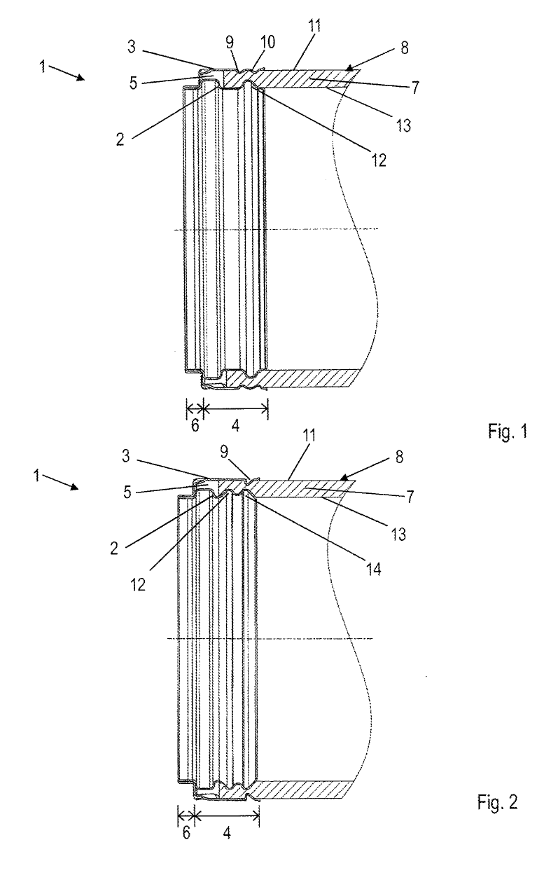

FIG. 2 shows a sectioned side view of a hose connector of a second embodiment, and

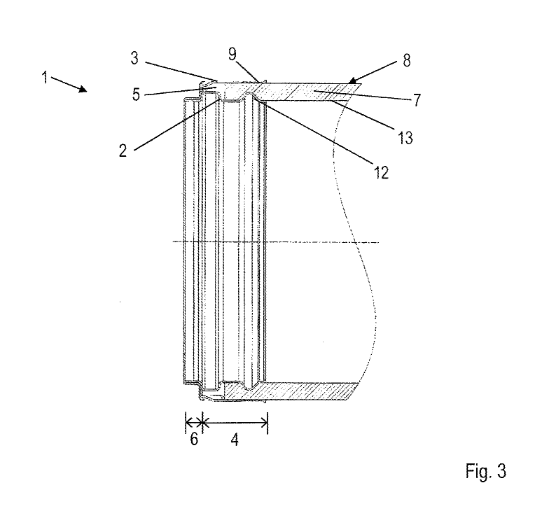

FIG. 3 shows a sectioned side view of a hose connector of a third embodiment.

In FIG. 1, a hose connector is represented in sectioned side view. The hose connector 1 comprises an inner sleeve 2 and an outer sleeve 3, which in a first end region 4 are spaced apart with the formation of an annular space 5, and in a second end region 6 bear one against the other. In this example, the hose connector 1 is made of a metal.

In the annular space 5 is accommodated one end 7 of a fluid line 8, which latter, in this example, is configured as a plastics pipe. In order to prevent release of the fluid line 8 from the house connector 1, both the inner sleeve 2 and the outer sleeve 3 have been plastically deformed in the end region by means of crimping, such that crimp folds 9, 10 of the outer sleeve 3 press radially inward into an outer side 11 at the end 7 of the fluid line 8, while a crimp fold 12 of the inner sleeve 2 presses radially outward into an inner side 13 of the fluid line. The crimp fold 10 of the outer sleeve 3 is here located closest to one end of the hose connector 1. As a result of this double-sided crimping, the material at the interface is reinforced and seal tightness, holding force and pressure resistance are increased.

In FIG. 2 is represented a modified embodiment of the hose connector 1, wherein, as in the following illustrative embodiment, the reference symbols of the previous embodiment are maintained. Unlike the embodiment according to FIG. 1, only a single crimp fold 9 is made in the outer sleeve 3 and two crimp folds 12, 14 are present in the inner sleeve 2. For the rest, this illustrative embodiment corresponds to the illustrative embodiment according to FIG. 1.

FIG. 3 shows a more widely modified embodiment of the hose connector 1. The crimp fold 9 in the outer sleeve 3 is here shaped out in the form of an external thread, which also presses into the outer side 11 of the end 7 of the fluid line and in this way produces a non-positive and positive connection. In turn, just one crimp fold 12 is shaped in the inner sleeve 2. The external thread enables relatively easily a secure, releasable connection of the hose connector 1 to other elements.

The invention is not limited to the embodiments previously described, but can be modified in a variety of ways. For instance, in particular the shape and number of the crimp folds can be varied. In this context, only the provision of a double-sided crimping, i.e. a permanent deformation both of the inner sleeve and of the outer sleeve, is essential, in order to realize a non-positive and positive connection between hose connector and fluid line.

All features and advantages arising from the claims, the description and the drawing, inclusive of design details, spatial arrangements and method steps, can be fundamental to the invention both in their own right and in the highly diverse combinations.

### REFERENCE SYMBOL LIST

1. hose connector

2. inner sleeve

3. outer sleeve

4. first end region

5. annular space

6. second end region

7. end

8. fluid line

9. crimp fold

10. crimp fold

11. outer side

12. crimp fold

13. inner side

14. crimp fold

1. A hose connector, comprising:
an inner sleeve and an outer sleeve,
an annular space, formed in a first end region between the inner sleeve and the outer sleeve, in which an end of a fluid line is accommodated,
wherein a non-positive and positive connection formed between the end of the fluid line and the hose connector by crimping the inner sleeve and outer sleeve in first end region.

2. The hose connector as claimed in claim 1, wherein at least one inwardly projecting crimp fold is formed into the outer sleeve and at least one outwardly projecting crimp fold is formed into the inner sleeve, and
wherein the outer sleeve, in a region of the inwardly projecting crimp fold, is pressed into an outer side of the end of the fluid line, and the inner sleeve, in a region of the outwardly projecting crimp fold, is pressed into an inner side of the end of the fluid line.

3. The hose connector as claimed in claim 2, wherein the inner sleeve is more plastically deformed in the region of the outwardly projecting crimp fold than the outer sleeve in the region of the inwardly projecting crimp fold.

4. The hose connector as claimed in claim 2, wherein the outwardly projecting crimp fold of the inner sleeve is configured in the form of an annular groove.

5. The hose connector as claimed in claim 2, wherein the outer sleeve has at least two inwardly projecting crimp folds, which are pressed into the end of the fluid line.

6. The hose connector as claimed in claim 1, wherein the inwardly projecting crimp fold of the outer sleeve is configured as an external thread.

7. The hose connector as claimed in claim 2, wherein the inwardly projecting crimp fold of the outer sleeve is configured as annular groove portions lying on at least one peripheral line.

8. The hose connector as claimed in claim 7, wherein the annular groove portions lie on two mutually parallel peripheral lines and are arranged with a gap in-between.

9. The hose connector as claimed in claim 2, wherein the inwardly projecting crimp fold of the outer sleeve ends axially closer to an end of the first end region than the outwardly projecting crimp fold of the inner sleeve.

10. The hose connector as claimed in claim 1, wherein the inner sleeve and the outer sleeve bear against one another in a second end region.

11. The hose connector as claimed in claim 10, wherein the inner sleeve and the outer sleeve, in the second end region, are materially connected to each other.

12. A method for the fluid-tight connection of one end of a fluid line to a hose connector as claimed in claim 1, comprising:
crimping the inner sleeve and the outer sleeve into the end of the fluid line, with the formation of a non-positive and positive connection.

13. The hose connector as claimed in claim 4, wherein the annular groove has at least one of a rectangular and/or a triangular cross section.

14. The hose connector as claimed in claim 5, wherein the at least two inwardly projecting crimp folds are pressed into the end of the fluid line with different strengths.

15. The hose connector as claimed in claim 10, wherein an outside diameter of the hose connector is smaller in the second end region than in the first end region.
